(19) United States
(12) Patent Application Publication
(10) Pub. No.: US 2010/0138401 A1
(43) Pub. Date: Jun. 3, 2010

(54) COMMUNICATIONS SYSTEM

(75) Inventor: Richard Simpson, Surrey (GB)

Correspondence Address: Cooper Legal Group LLC, 6505 Rockside Road, Suite 330, Independence, OH, 44131, US

(73) Assignee: The Listening Company Ltd., Surrey (GB)

(21) Appl. No.: 12/626,856

(22) Filed: Nov. 27, 2009

(30) Foreign Application Priority Data
Nov. 28, 2008 (GB) 0821813.3

(51) Int. Cl. G06F 15/16; G06F 17/30; H04M 3/00; G06F 17/00

(52) U.S. Cl. 707/706; 709/219; 379/265.01; 707/E17.108; 715/205; 707/769

(57) ABSTRACT

A communications system is disclosed in which a user device can be used to navigate a network. A user can click on hyperlinks to move between web pages, and the user clicks on a hyperlink provided by a search engine server. The search engine server sends a data package to a data file generating server upon a user clicking on a hyperlink. The data file generating server prepares a cookie file according to information received from the search engine server, and downloads the cookie file to the user device. A content supply server prepares a web page according to a user's http request and according to information received in the cookie file received from the user device.

### RELATED APPLICATION

This application claims priority to 0821813.3, filed on Nov. 28, 2008, entitled “COMMUNICATIONS SYSTEM” which is hereby incorporated by reference in its entirety

### BACKGROUND

Typically users navigate the internet by clicking on hyperlinks. Each hyperlink directs a user to a particular address.

A list of hyperlinks is typically provided by a search engine in response to key words entered by a user. Commonly, a search engine provides, in addition to the standard search results, advertisements relevant to the search which are known as ‘banner’ advertisements, or sponsored advertisements. Sponsored advertisements are generated according to key words and phrases entered used by the web user in the search. A click on the advertisement directs the user's web browser to the advertiser's web site. A user may also arrive at an advertiser's website by clicking on a banner advertisement or an embedded hyperlink in an email.

An advantage of this form of advertising is that it is possible to track activities that lead users to a website. In addition, it is possible to analyse connections between the method by which a user arrived at a website, including the user's search terms, and their subsequent interaction with the website. In this way, it is possible to target advertising and select search terms that will increase traffic to a website.

A problem arises when a potential customer finds a telephone number on a website and makes a telephone call to complete a transaction. In these circumstances information regarding the method of the user's arrival at the website, including original search terms is lost. While it would be possible for telephone operators to interview users about these search terms, this process would be prone to inaccuracy and subject to operator error; in addition it would undesirably lengthen call handling times.

US 2004/0107137 relates to a system in which telephone orders or sales can be linked to a particular marketing campaign. In this system a website is programmed such that, when a user is directed to the website from a search engine, the data concerning the search engine and key word combination are used to look up a unique telephone number, which is then displayed for the user. In this way it is possible to derive the search terms used for generating a sale by analysing the telephone number used.

In US 2004/0107137 the unique telephone number is not indicative of whether the user arrived at the website via a ‘sponsored’ link or a standard hyperlink. A further disadvantage is that the website host requires a large number of telephone lines, which may be expensive and impractical.

### SUMMARY

There is a need for a system that increases telephone activity and enables identification of web-based information which would otherwise be lost when a user makes telephone contact with a website host. In particular, a technical solution is required to avoid the need for a large number of telephone lines. It is particularly desirable that the solution to this problem is invisible to an end user of a website and that the solution can be easily applied to existing systems (e.g., without substantial adaptation needed).

According to the present disclosure there is provided a communications system comprising: a server arranged to provide a hyperlink; a data file generating server; and a content supply server, provided separately from the data file generating server; wherein the server arranged to provide the hyperlink is arranged to send information about the hyperlink to the data file generating server when a user clicks on the hyperlink; wherein the data file generating server comprises: a data file generator arranged to generate a data file including information about the hyperlink; and a download manager arranged to download the data file to a destination associated with the user; and wherein the content supply server comprises: a receiver unit arranged to receive data from a user, the received data including a request for a web page, and including the data file downloaded from the data file generating server; a control unit arranged to provide content that depends on the information in the data file; and a transmitter unit arranged to send content provided by the control unit to the user in response to the user's request.

In this communication system a data file including information about a hyperlink is created when a user clicks on the hyperlink. The data file is generated by the data file generating server and, preferably, is downloaded to a user device. A copy of the data file may then be supplied to the content supply server by the user so that the information in the data file can be used when a web page is created or provided.

In this way, a web page may be provided for a user including content that depends on characteristics of the hyperlink they have clicked on. Thus, it may be possible to identify characteristics of a source hyperlink from the additional content when a user makes contact with the web page host by telephone. For example, the appearance of a web page may depend on which hyperlink is used to access the web page. In this way, it may be possible to determine the origin of a hyperlink (such as whether it is supplied by a search engine, E-mail or display ad). This may be useful, for example, in tracking users' activities interacting with a web site.

By generating a data file in a data file generating server which is separate from the content supply server it may be possible to use the data file generating server to control the operation of the content supply server. For instance data may be included in the data file, the presence of which will cause a specified action in the content supply server.

In addition, by generating the data file in the data file generating server it may be possible to distribute the processing requirements between the data file generating server and the content supply server. In particular it may be possible to reduce additional processing that is to be carried out by the content supply server. Thus, the bulk of the processing necessary to achieve the results of the disclosure may be undertaken by the data file generating server. This may be desirable for a content supplier because an existing content supply server may be easily modified to become compatible with the present disclosure without experiencing significant additional processing demands.

The hyperlink may include a clickable item in an email, a web page or other electronic medium. The hyperlink may be embedded in a source and may appear as text, highlighted text or an image, for example. The hyperlink may be sponsored or unsponsored.

Preferably the transmitter unit in the content supply server sends a web page to a user, including content from which a source hyperlink can be determined. For example, the content in the web page may include a reference number, having encoded elements that identify characteristics of the source hyperlink. The reference number may be created by the control unit of the content supply server according to rules stored in the data storage unit and depending on information in the received data file. Thus, if a user telephones the contact defined in the contact information it may be possible for a telephone operator or an IVR (Interactive Voice Response) system to determine aspects of the source hyperlink by requesting the reference number. For example, it may be possible to identify characteristics of an email in which the source hyperlink was embedded.

The user may send the request for a web page to the content supply server together with or separately from the data file. Where these items are sent separately, they may be components in a request/response conversation between a browser operating on a user device and the content supply server.

Contact information may be provided by a data storage unit in the communication system, and the contact information may be displayed in a web page together with the content that depends on the information in the data file. However, contact information may be displayed separately from the content that depends on the information in the data file, for example on separate web pages.

Preferably the contact information includes a telephone number. The operator who receives the user's call may be trained to request the reference number from the user. Alternatively the reference number may be requested in an IVR system.

The contact information may include content that is at least partially dependent on information in the received data file. For example, the contact information may include an extension number that is provided by the control unit, according to rules stored in the data storage unit and depending on the information in the received data file. The extension number dialled by a user may be indicative of characteristics of the source hyperlink.

The content provided by the control unit may be any characterising content further to the contact information. For example, the control unit may provide the name of an individual or department which may be indicative of a characteristic of a source hyperlink.

The data file generator may be arranged to operate according to predetermined rules stored in a data storage unit.

The communication system may further comprise a user computer system which is arranged to receive a data file from the data file generating server. The computer system preferably comprises data storage means for storing the data file.

Preferably the data file is a cookie which is stored in the data storage means of the user computer system automatically when it is received. Preferably the user computer system is arranged to send a copy of the cookie to the content supply server when it is requested to do so. In this way, the information about the hyperlink may be supplied to the content supply server directly from the user. Thus, a standard content supply server may require a minimum of adaptation because such servers may already be configured to receive data from user computer systems in this way.

The server arranged to provide the hyperlink may be a search engine server. Preferably the hyperlink is one of a plurality of hyperlinks provided by any of a multitude of sources (search engines, E-mails, display ads) in response to attributes acted upon by the user.

Preferably the data file generating server is auxiliary to the search engine server. However, in an alternative arrangement the data file generating server may also operate as a search engine server. Thus, when the user clicks on the source hyperlink the search engine server may generate a data file and cause this to be stored on the user's computer.

The server arranged to provide the hyperlink (which may be a search engine server) may be arranged to send the data file generating server information about an attribute such as a keyword, used in the provision of the hyperlink so that the data file generator can generate a data file including information about the attribute and so that the control unit in the content supply server can provide content that depends on the attribute by making use of the information in the data file.

Preferably the control unit is arranged to provide content, in the form of a personal banner that depends on both an attribute and the source hyperlink that the user clicked on. For example, the control unit may generate a telephone number including a single extension number that is indicative of both of these variables, or the control unit may instruct an external module to generate the telephone number and/or the extension number.

Preferably the data file generator is arranged to generate a single data file including information about a search term, and information about the hyperlink that the user clicked on. However, in an alternative arrangement two separate data files may be generated and downloaded to a user device.

The communication system may further comprise an administrator computer system for establishing general operational parameters in the communication system. As well as establishing the rules in the content supply server, the administrator computer system may establish the rules of operation of the data file generating server and/or the server that provides the hyperlink. For the server that provides the hyperlink the administrator computer system may establish the rules for the generating sponsored hyperlinks.

The communication system may further comprise a call centre computer system, which may be arranged to send information to the content supply server including information about the contact defined in the contact information. The control unit in the content supply server may provide content that depends on the received information about the contact.

Preferably the call centre computer system sends the content supply server information about the status of a contact. In this way, the content supply server may be supplied with real-time information indicative of the availability of the contact. This information can be forwarded to a user in a web page. In one example, the web page may include content including the number of telephone operators available, the propensity of visitors to the website to make contact using the displayed contact details, the average length of a call and its associated work, and an acceptable average time to answer a call.

The control unit in the content supply server may be arranged to provide content that depends on information in the data file received from the user and information received from the call centre computer system. In one arrangement the control unit in the content supply server may exclude a telephone number from the contact information in the event that an operator is likely to be unavailable. This may occur if the number of pages provided by the content supply server exceeds a certain threshold in a predetermined period of time. Preferably the control unit is arranged to provide an “out of service” banner, rather than simply excluding a telephone number from the contact information.

In another embodiment the call centre computer system may be arranged to send information about the status of the contact to the data file generating server. The data file generating server may be arranged to create a data file including information about the status of the contact and to send this data file to a user. This may be desirable because it may shift additional computational demands from the content supply server to the data file generating server.

The communication system may further comprise a reference number generator which is arranged to generate a reference number using predetermined rules. Preferably the generated reference number depends on the information in the data file received at the content supply server.

Preferably the data file generating server comprises the reference number generator. It may be desirable for the data file generating server to generate the reference number in order to save on processing overheads in the content supply server. However, the data file generating server may be included in the content supply server or in some other external server.

The reference number generator in the data file generating server may operate when instructions are received from the content supply server. A generated reference number may be returned to the content supply server so that it can be sent to a user device. Preferably the generated reference number is a telephone number and an extension number.

Preferably the reference number generator is arranged to analyse the data relating to the hyperlink included in the data file received at the content supply server, and to create a suitable reference number according to predetermined rules. For example, the reference number generator may extract a suitable reference number from a database. By reverse engineering the reference number it may be possible to determine characteristics of the source hyperlink.

According to another aspect of the present disclosure there is provided a method of providing a user with content over the internet comprising: providing a hyperlink for a user to select; sending information about the hyperlink to a data file generating server when the user clicks on the hyperlink; generating a data file at the data file generating server, the data file including information about the hyperlink; downloading the data file to a destination associated with the user; receiving a request for a web page from a user at a content supply server which is provided separately from the data file generating server; receiving the generated data file from the user at the content supply server; providing content that depends on the information in the data file, according to predetermined rules; and sending content to the user in response to the user's request, the content including the provided content that depends on the information in the data file.

Preferably the method also involves: establishing a telephone call between the user and a call centre; and receiving information from the user in the telephone call, wherein the received information relates to the content provided to the user that depends on the information in the data file.

In this way it may be possible to determine characteristics of the hyperlink that the user clicked on because the content that is provided to the user depends on information about the hyperlink included in the data file. Thus, if a user were to arrive at a web page and make a telephone call in order to complete a transaction it would be possible to determine characteristics of the hyperlink that the user clicked on by interviewing the user.

Preferably the method involves generating a reference number containing encoded information about the hyperlink that the user clicked on. By disguising the reference number as a telephone extension number, the user may enter the relevant information without even being prompted to do so by a telephone operator or an IVR system.

One or more of the apparatus features presented herein may be provided as method features and vice-versa.

One or more of the servers provided herein may operate according to instructions provided in computer readable storage medium. Program modules may be provided corresponding to the apparatus or method features described herein.

### DESCRIPTION OF THE DRAWINGS

In order that the disclosure may be more readily understood, reference will now be made, by way of example to drawings, in which:

FIG. 1 is a schematic diagram illustrating a communication system in which one or more provisions of the disclosure herein may be implemented;

FIG. 2 is a schematic diagram illustrating information flow in a communication system according to one or more of the provisions set forth herein;

FIG. 3 is a schematic diagram illustrating components of a data file generating server operating in a communication system in accordance with one or more of the provisions set forth herein;

FIG. 4 is a diagram illustrating a logical flow of information in a data file generating server according to one or more of the provisions set forth herein;

FIG. 5 is a schematic diagram illustrating components of a content supply server operating in a communication system according to one or more of the provisions set forth herein;

FIG. 6 is a diagram illustrating a logical flow of information in a content supply server according to one or more of the provisions set forth herein; and

FIG. 7 is a diagram illustrating a logical flow of information within a call centre operating in a communication system according to one or more of the provisions set forth herein.

### DETAILED DESCRIPTION

The present disclosure relates to one or more server systems and/or a method of supplying a user with content over the internet. In particular the disclosure relates to a communications system that encourages user activity on websites and enables improved tracking of users' interactions with websites.

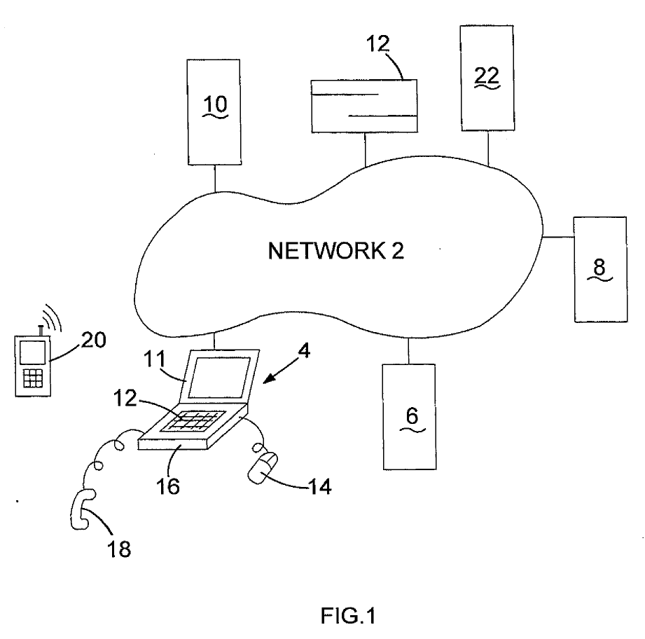

FIG. 1 is a schematic diagram illustrating a communication system in which devices are arranged in communication over a network 2. In particular, the following devices are provided: a user device 4, a search engine server 6, a data file generating server 8, a content supply server 10, a call centre 12, an administrator device 22, and a cellular telephone 20. The devices may be connected to the network with wires or by wireless connection.

The example user device 4 illustrated comprises a laptop computer comprising a screen 11, a keyboard 12, and a processing unit 16. A mouse 14, and a handset 18 are arranged in connection with the user device 4.

The user device 4 is connected to the network 2 so that a user can access the internet. The mouse 14 or keyboard 16 may be used so that the user can navigate between web pages. Typically the user will click on hyperlinks to move between web pages; as is known in the art, this may be accomplished by manoeuvring a pointer displayed on the screen 11 using the mouse 14.

The handset 18 may be used in telephone calls over the internet, using the Voice over the Internet Protocol (VoIP). In addition, the handset may be used in telephone calls over the Plain Old Telephone Network (POTS).

The user may search for information over the internet using a web page supplied by a source, i.e. in this instance a search engine. As a matter of practice the user may use the user device 4 to access a search engine web page by accessing the search engine server 6 over the network 2. Typically a user inputs a number of search terms to the search engine web page, and the search engine server 6 generates a list of hyperlinks, which depend on the search terms entered. The user reviews the list of hyperlinks and makes a selection by clicking on their chosen hyperlink.

In the present system the search engine server 6 is arranged to send a package of data to the data file generating server 8 upon a user clicking on a hyperlink. The package of data contains information about the user's selection and the search terms used to generate the list of hyperlinks.

The data file generating server 8 is arranged to prepare a cookie file, according to information received from the search engine server 6. In particular the cookie file includes encoded information relevant to the user's hyperlink selection and the attributes, i.e. in this instance the search terms. The data file generating server 8 is arranged to send the cookie file, once prepared, to the to the user device 4 together with a re-direction header so that the user is directed to content relevant to their hyperlink selection.

Upon receipt of the cookie file from the data file generating server 8, the user device 4 stores the cookie file to memory. If a corresponding cookie file already exists in memory then the user device 4 overwrites this with the new cookie file.

Upon receipt of the re-direction header from the data file generating server 8, the user device 4 sends a HTTP request to a content supply server 10. The content supply server 10 responds by requesting a particular cookie file from the user device 4. The user device 4 retrieves the relevant cookie file from memory and sends a copy of the file to the content supply server 10.

The content supply server 10 prepares a web page according to the HTTP request from the user device 4. The information in the cookie is used in the preparation of tailored information for inclusion on the web page. In particular, the content supply server 10 requests a banner from the data file generating server 8.

The data file generating server 8 receives the request from a request for a banner from the content supply server 10 and generates a reference number for the banner using a reference number generator. The generated reference number is a unique telephone number/extension number having encoded information which is characteristic of the user's hyperlink selection and the search terms used by the user. The content supply server 10 includes the banner received from the data file generating server 8 in a web page and sends this to the user device 4.

The content supply server 10 is also arranged to receive data, relating to the availability of telephone operators, from the call centre 12, and it can modify the content in web pages using this information. In one example the content supply server 10 can control the rate at which banners including contact telephone numbers are provided to users in order to avoid overloading a call centre with incoming telephone calls. Specifically, the content supply server 10 is arranged to provide a banner with a contact telephone number if the number of calls in a queue is less than a predetermined threshold, if the average wait time for calls is less than a predetermined threshold, and if the number of banners supplied in the last minute is less than a predetermined threshold. If these requirements are not met the content supply server 10 is arranged to provide users with an “out of service” banner that does not include a telephone number.

The cellular telephone 20 or the handset 18 may be used by the user for telephone calls. The user may note a telephone number from a website, according to information displayed by the user device 4, and make a telephone call. Typically the user is routed to an IVR system in the call centre 12 for telephone calls that are relevant to the website.

The administrator device 22 is arranged for establishing and controlling the parameters of the data file generating server 8, the content supply server 10, and the source, in this instance, the search engine server 6. In particular, the administrator device 22 communicates with the search engine server 6 to determine the rules for establishing a sponsored link. The administrator device 22 also establishes the rules for generating cookies for all sources used by the data file generating server 8 and the rules for generating reference numbers used by the content supply server.

A number of servers have been described with reference to FIG. 1 as though they were separate entities. While the content supply server is provided separately in logic from the data file generating server, it would be apparent to the skilled person that other combinations of servers could be provided as a single server fulfilling multiple functions.

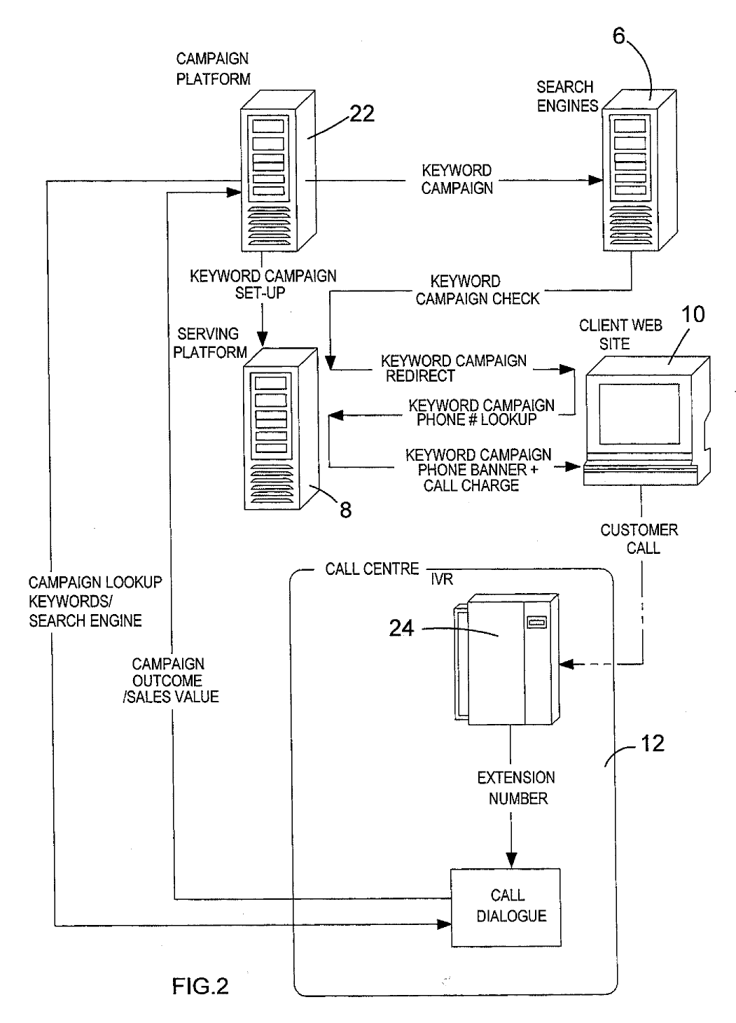

FIG. 2 is a diagram illustrating a flow of information in the network. As may be seen, the administrator device 22 establishes which attributes, in this case, keywords, will generate sponsored hyperlinks by communicating with the search engine server 6. Upon selection of a sponsored hyperlink the search engine server 6 sends a package of information to the data file generating server 8, including information about the keywords entered.

The data file generating server 8 sends the user device 4 a re-direct header to re-direct the user device to the content supply server 10.

When a user decides to make a telephone call in order to discuss or complete a transaction, on the basis of information in the web page, the user's call is received by an IVR system 24 in the call centre 12. A conversation then ensues. Preferably the user dials an extension number on the basis of information supplied in the website. The extension number is a reference number from which attributes, in this case, search terms and characteristics of the source can be determined. If the source hyperlink was embedded in an email or other electronic file then it may be possible to determine characteristics of that email or file from the reference number.

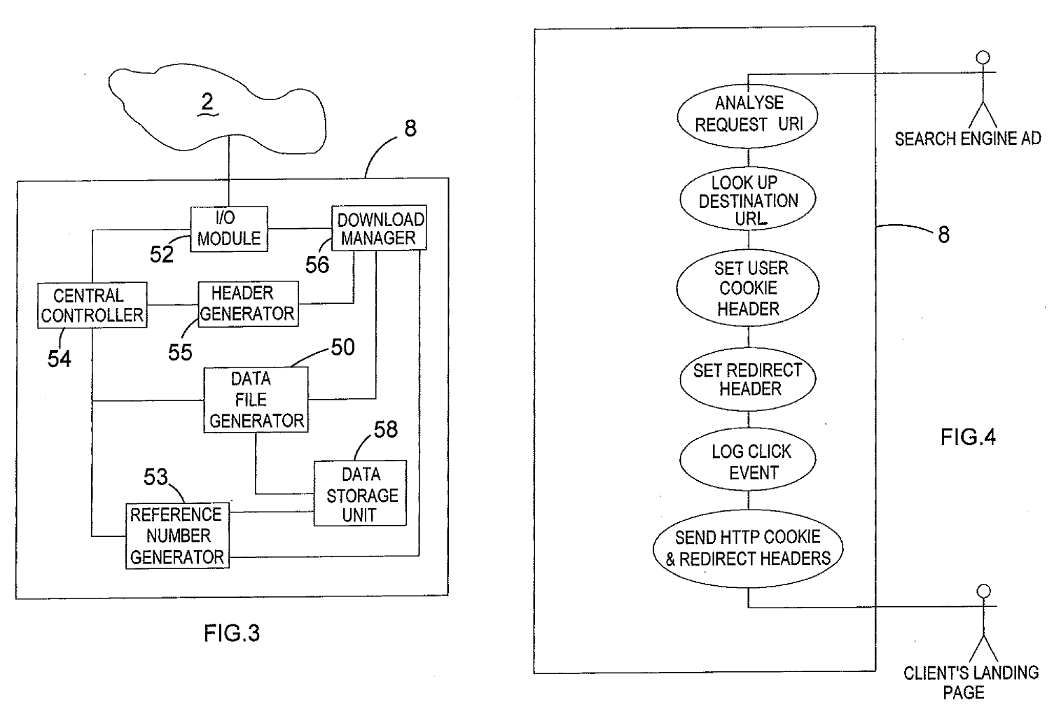

FIG. 3 illustrates the components of a data file generating server 8. The data file generating server 8 is connected to the network to via an input/output module 52. The input/output module 52 is connected to a central controller 54 and a download manager 56. Both of these components are connected to a data file generator 50 which also comprises a connection to a data storage unit 58. The central controller 54 is connected to a header generator 55 which is also connected to the download manager 56. Finally, the central controller 54 is connected to a reference number generator 53 which has respective connections with the data storage unit 58 and the download manager 56.

In operation, the data file generating server 8 receives a data package from the source, in this case, a search engine server 6, the data package comprising data relating to characteristics of the hyperlink selected by the user, and data relating to characteristics of the search terms used. The data package is received at the central controller 54, via the input/output module 52. The central controller 54 detects the data packages and sends it to the data file generator 50 for analysis. The data file generator 50 is arranged to create a cookie file according to rules stored in the data storage unit 58.

The format of the data package received at the data file generating server 8 from the source, in this case, the search engine server 6 may be dependent on the search engine provider. The data file generator 50 is arranged to create a common type of cookie which is independent of the source, in this case, the search engine provider. (Although, of course, data identifying the search engine provider may be included in the cookie).

Once the cookie has been prepared by the data file generator 50 it is sent to the download manager 56 so that it can be sent to the user device 4. The cookie is stored in memory on the user device 4 automatically, and this process is generally invisible to a user.

The central controller 54 instructs the header generator 55 to generate a re-direct header to be sent to the user device 4. The header generator 55 analyses the characteristics of the hyperlink selected by the user by considering the data package received from the source, in this case, search engine server 6. The header generator 55 then generates a header that will re-direct the user to a web page that is relevant to their selected hyperlink. The re-direct header may be sent to the user together with the cookie or separately there from, via the download manager 56.

In this way, the presence of the data file generating server 8 is generally invisible to a user. By clicking on a hyperlink the user is directed to the data file generating server 8 but immediately re-directed to an appropriate web page, and in the background a cookie is stored on the user device 4.

FIG. 4 is a diagram illustrating the flow of information in the data file generating server 8. As may be seen, the central controller 54 analyses the data received from the search engine server 6. The data received from the source, in this case, the search engine server 6 may be contained within the URL, URI and HTTP referrer strings, and these strings may have encoded information which is sufficient to determine attributes, in this case, search terms, identify link banners, and identify desirable target destinations.

The data file generating server 8 is arranged to log each click event that is processed for future reference. This information is stored in the data storage unit 58.

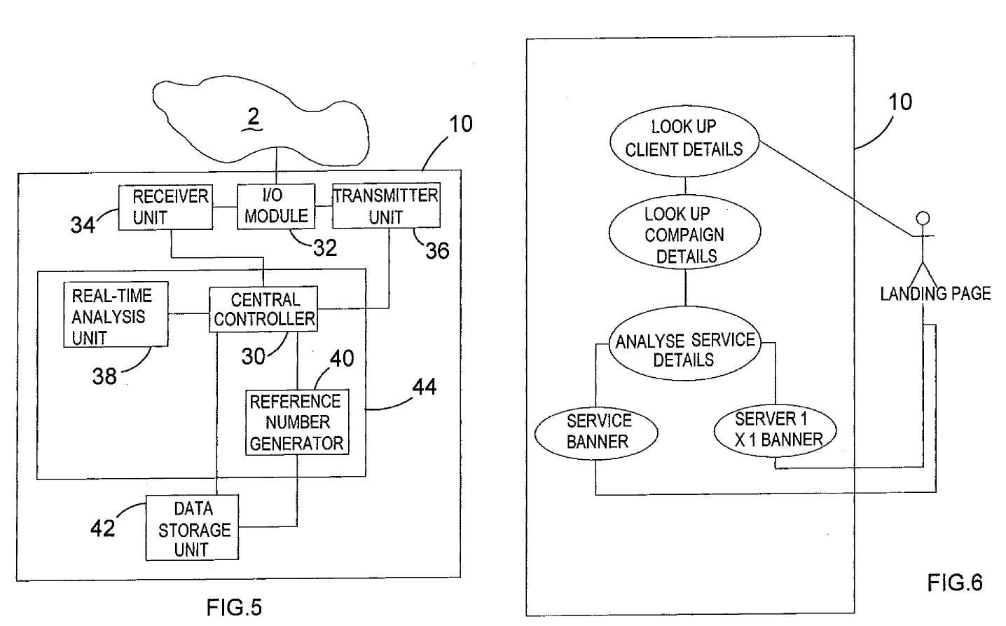

FIG. 5 is a schematic diagram illustrating the components of a content supply server 10. The content supply server 10 comprises an input/output module 32, which is connected to a receiver unit 34 and a transmitter unit 36. The receiver unit 34 is connected to a central controller 30 which also comprises connections to the transmitter unit 36, a data storage unit 42, and a real-time analysis unit 38. Optionally, the central controller 30 can be connected to a reference number generator 40 which comprises a respective connection to the data storage unit 42. The real-time analysis unit 38, the central controller 30, and the reference number generator 40 are components in a control unit 44.

In operation, the content supply server 10 is arranged to receive data from the network 2. All data are received by the input/output module 32, and inbound data are routed to the receiver unit 34. In particular, the receiver unit 34 is arranged to receive a request for a web page from a user device 4. The receiver unit 34 communicates web page requests to the central controller 30.

The central controller 30 analyses web page requests and communicates with the data storage unit 42 to determine whether a cookie is required for the requested web page. The data storage unit 42 maintains a list of web pages stored in the content supply server 10, and includes details of whether a cookie is required.

In the circumstances where a cookie is required, the central controller 30 instructs the transmitter unit 36 to request the cookie from the user device 4. The user device 4 responds by sending the appropriate cookie if such a data file can be found on the user device 4. When a cookie is received by the receiver unit 34 it is passed to the central controller 30.

The central controller 30 requests the generation of a banner including a reference number, upon receipt of a cookie and according to rules stored in the data storage unit 42. Preferably the central controller 30 sends a request for a banner to the data file generating server 8, via the transmitter unit 36 and the input/output module 32.

When the central controller 30 in the content supply server 10 requests the generation of a banner by the data file generating server 8, this request is received at the input/output module 52 of the data file generating server 8. The central controller 54 in the data file generating server instructs the reference number generator 53 to create a reference number, according to data in the cookie received at the content supply server 10. The reference number generator 53 operates in accordance with predetermined rules stored in the data storage unit 58.

A plurality of reference numbers will be included in a database in the data storage unit 58, and the reference numbers may be pre-allocated particular search terms. Thus, if a search term matches an item in the database the reference number generator 53 can simply extract the relevant reference number.

Once a reference number is created by the reference number generator 53 in the data file generating server 8, it is sent to the content supply server 10 via the download manager 56 and the input/output module 52. The reference number is received at the content supply server 10 and its central controller 30 is arranged to prepare the web page that has been requested by the user device 4. This is achieved by obtaining the relevant data from the data storage unit 42. Typically the web page is formed of static objects but comprises a number of dynamic slots that can be modified by the central controller 30. The reference number from the data file generating server 8 is inserted in a dynamic slot. Typically the reference number is displayed as the extension number to a telephone number, or it may be the entire telephone number.

The content supply server 10 is arranged to receive real-time information from the call centre 12 regarding the call centre status. For example, the call centre 12 may inform the content supply server 10 of the availability of telephone operators, and the likely hold time for a telephone call. This information is received by the input/output module 32, passed to the receiver unit 34 and the central controller 30, and analysed by the real-time analysis unit 38. The real-time analysis unit 38 is arranged to provide the central controller 30 with suitable information for display in a web page, according to the information received from the call centre 12. The central controller 30 is arranged to insert information from the real-time analysis unit 38 in a dynamic slot in a web page.

Once the web page has been prepared, the central controller 30 sends it to the transmitter unit 36 from where it is relayed to the user device 4.

In an alternative embodiment the content supply server 10 may comprise its own reference number generator 40. In this arrangement it is not necessary for the content supply server 10 to request that the data file generating server 8 generates a reference number; the generation of a reference number can be undertaken internally in the content supply server 10.

FIG. 6 is a diagram illustrating the flow of information in the content supply server 10. As may be seen, the content supply server 10 retrieves a web page from the data storage unit 42, relevant to the request received (referred to as looking up client details in FIG. 6). The relevant rules and controls for that particular web page are also retrieved from the data storage unit 42. A reference number is then generated according to information in the cookie, either by the content supply server 10 or by the data file generating server 8. The reference number is then supplied to the user device 4 as a banner, the size of which depends on rules stored in the data storage unit 42.

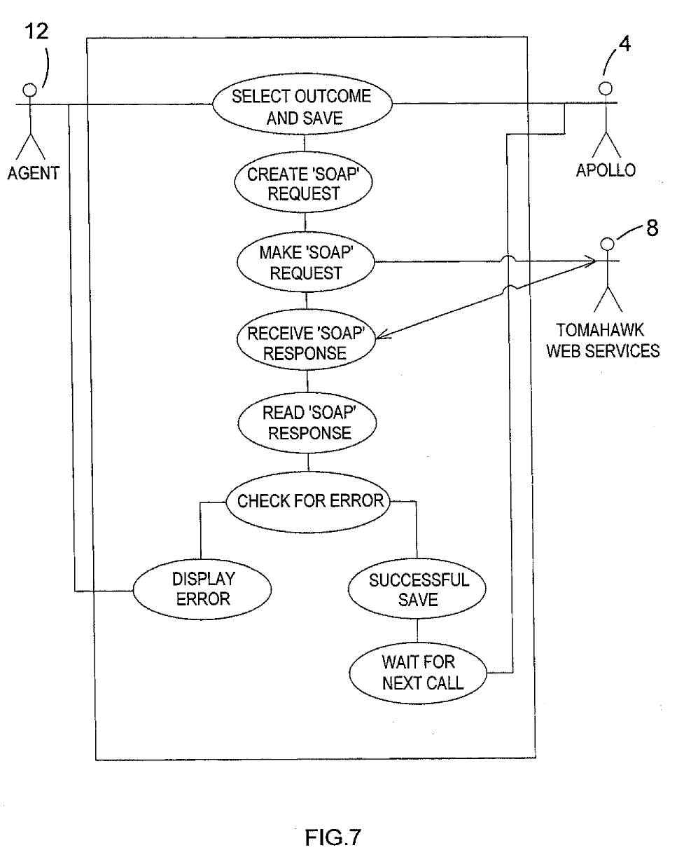

FIG. 7 is a diagram illustrating the flow of information in the call centre 12. Upon receipt of a telephone call a request for a reference number is created by an IVR at the call centre 12. The user inputs their reference number and the response is analysed at the call centre 12 to determine information about the source and attributes associated with that particular reference number. This analysis may reveal attributes of the hyperlink clicked on by the user such as information about the electronic file in which the hyperlink is embedded or information about the search terms used to create the hyperlink.

Outcome information is captured during a telephone conversation between the user and the call centre 12. This information may include details such as whether the call resulted in a sale and the value of any such sale. Outcome information is uploaded to the data file generating server 8 and/or the administrator device 22 so that users' interactions with a web page can be tracked and linked to the original source and attributes. In this way it may be possible to identify sources and attributes that involve desirable call centre activity.

What is claimed is:

1. A communications system comprising:
a server configured to provide a hyperlink;
a data file generating server; and
a content supply server, provided separately from the data file generating server;
wherein the server configured to provide the hyperlink is configured to send information about the hyperlink to the data file generating server when a user clicks on the hyperlink;
wherein the data file generating server comprises:
a data file generator configured to generate a data file including information about the hyperlink; and
a download manager configured to download the data file to a destination associated with the user;
and wherein the content supply server comprises:
a receiver unit configured to receive data from a user, the received data including a request for a web page, and including the data file downloaded from the data file generating server;
a control unit configured to provide content that depends on the information in the data file; and
a transmitter unit configured to send content provided by the control unit to the user in response to the user's request.

2. A communication system according to claim 1 comprising a user computer system which is configured to receive a data file from the data file generating server, wherein the computer system comprises data storage means for storing the data file.

3. A communication system according to claim 1 wherein the server configured to provide the hyperlink is a search engine server.

4. A communication system according claim 3 wherein the search engine server is configured to send the data file generating server information about a search term used in the provision of the hyperlink so that the data file generator can generate a data file including information about the search term, and so that the control unit in the content supply server can provide content that depends on the search term by making use of the information in the data file.

5. A communication system according to claim 1 comprising an administrator computer system for establishing the rules stored in the data storage unit of the content supply server.

6. A communication system according to claim 1 comprising a call centre computer system, wherein the call centre computer system is configured to send information to the content supply server including information about the contact defined in the contact information so that the control unit in the content supply server can provide content that depends on the received information about the contact.

7. A communication system according to claim 1 comprising a reference number generator which is configured to generate a reference number using predetermined rules, wherein the generated reference number depends on information in the data file received at the content supply server.

8. A communication system according to claim 7 wherein the data file generating server comprises the reference number generator.

9. A method of providing a user with content over the internet comprising:
providing a hyperlink for a user to select;
sending information about the hyperlink to a data file generating server when the user clicks on the hyperlink;
generating a data file at the data file generating server, the data file including information about the hyperlink;
downloading the data file to a destination associated with the user;
receiving a request for a web page from a user at a content supply server which is provided separately from the data file generating server;
receiving the generated data file from the user at the content supply server;
providing content that depends on the information in the data file, according to predetermined rules; and
sending content to the user in response to the user's request, the content including the provided content that depends on the information in the data file.

10. A method according to claim 9 comprising:
establishing a telephone call between the user and a call centre; and
receiving information from the user in the telephone call, wherein the received information relates to the content provided to the user that depends on the information in the data file.
